(19) United States
(12) Patent Application Publication
(10) Pub. No.: US 2015/0017554 A1
(43) Pub. Date: Jan. 15, 2015

(54) PROCESS FOR PRODUCING TRANSPORT AND STORAGE-STABLE OXYGEN-CONSUMING ELECTRODE

(71) Applicant: BAYER MATERIAL SCIENCE AG, Leverkusen (DE)

(72) Inventors: Andreas BULAN, Langenfeld (DE); Rainer WEBER, Odenthal (DE); Michael STELTER, Wegefarth (DE); Hartmund BOMBACH, Freiberg (DE); Katja PALM, Freiberg (DE)

(73) Assignee: BAYER MATERIALSCIENCE AG, Leverkusen (DE)

(21) Appl. No.: 14/327,788

(22) Filed: Jul. 10, 2014

(30) Foreign Application Priority Data
Jul. 12, 2013 (DE) 10 2013 213 740.0

(51) Int. Cl. H01M 4/90; C25D 7/00; C25D 5/00; C25D 5/48; C25B 1/14; C25B 11/04

(52) U.S. Cl. CPC H01M 4/9075; C25B 1/14; C25B 11/0405; C25D 5/00; C25D 5/48; C25D 7/00; H01M 4/9041
USPC 429/405; 205/532; 204/290.01; 205/263; 205/220; 429/523

(57) ABSTRACT

A process for producing oxygen-consuming electrodes, in particular for use in chloralkali electrolysis, which display good transport capability and storage capability. In the process, a silver oxide-containing sheet-like structure as intermediate is electrochemically reduced. Also disclosed are methods of using these electrodes in chloralkali electrolysis or fuel cell technology or in metal-air batteries, and the fuel cells and metal-air batteries produced.

This application claims priority of German Patent Application No. 10 2013 213 740.0, filed Jul. 12, 2013, the entire contents of which are incorporated herein by reference.

The invention relates to the production of oxygen-consuming electrodes, especially for use in chloralkali electrolysis, in which silver oxide-based sheet-like structures are electrochemically reduced in an electrolyte consisting of an aqueous solution of an alkali metal hydroxide having a concentration of at least 0.001 mol/l. The oxygen-consuming electrode formed displays good transport capability and storage capability. The invention further relates to the use of these electrodes in chloralkali electrolysis, metal-air batteries or fuel cell technology.

The invention proceeds from the processes known per se for producing oxygen-consuming electrodes which are configured as gas diffusion electrodes and usually comprise an electrically conductive support and a gas diffusion layer having a catalytically active component.

Various proposals for producing and operating oxygen-consuming electrodes in electrolysis cells on an industrial scale are basically known from the prior art. The fundamental idea is to replace the hydrogen-evolving cathode of the electrolysis (for example in chloralkali electrolysis) by the oxygen-consuming electrode (cathode). Anode and cathode are separated by an ion-exchange membrane. An overview of the possible cell designs and solutions may be found in the publication by Moussallem et al “Chlor-Alkali Electrolysis with Oxygen Depolarized Cathodes: History, Present Status and Future Prospects”, J. Appl. Electrochem. 38 (2008) 1177-1194.

The oxygen-consuming electrode, hereinafter also referred to as OCE for short, has to meet a number of requirements in order to be able to be used in industrial electrolysers. Thus, the catalyst and all other materials used have to be chemically stable to sodium hydroxide solution having a concentration of about 32% by weight and to pure oxygen at a temperature of typically 80-90° C. Likewise, a high degree of mechanical stability is required since the electrodes are installed and operated in electrolysers having a size of usually more than 2 m² in area (industrial size). Further desirable properties are: a high electrical conductivity, a low layer thickness, a high internal surface area and a high electrochemical activity of the electrode catalyst. Suitable hydrophobic and hydrophilic pores and a corresponding pore structure for the conduction of gas and electrolyte are, in particular, likewise necessary, as is impermeability so that gas and liquid space remain effectively separated from one another. Long-term stability and low production costs are further particular requirements which an industrially usable oxygen-consuming electrode has to meet.

An oxygen-consuming electrode typically consists of a support element, for example a plate made of porous metal or a woven mesh made of metal wires, and an electrochemically active coating. The electrochemically active coating is microporous and consists of hydrophilic and hydrophobic constituents. The hydrophobic constituents inhibit the penetration of electrolyte and thus keep the corresponding pores free for transport of oxygen to the catalytically active sites in the electrode. The hydrophilic constituents make it possible for the electrolyte to penetrate through to the catalytically active sites and transport away the hydroxide ions. As hydrophobic component, use is generally made of a fluorine-containing polymer such as polytetrafluoroethylene (PTFE) which additionally serves as polymeric binder of the catalyst. In the case of electrodes having a silver-catalyst, the silver serves as hydrophilic component.

Many compounds have been described as catalyst for the reduction of oxygen.

Thus, there are reports describing the use of palladium, ruthenium, gold, nickel, oxides and sulphides of transition metals, metal porphyrins and phthalocyanines, and perovskites as catalyst for oxygen-consuming electrodes.

However, only platinum and silver have attained practical importance as catalyst for the reduction of oxygen in alkaline solutions.

Platinum has a very high catalytic activity for the reduction of oxygen. Owing to the high costs of platinum, this is used exclusively in supported form. A preferred support material is carbon. Carbon conducts the electric current to the platinum catalyst. The pores in the carbon particles can be made hydrophilic by oxidation of the surface and as a result become suitable for transport of the electrolyte. OCEs having carbon-supported platinum catalysts display good performance. However, the chemical stability of carbon-supported platinum electrodes in long-term operation is unsatisfactory, presumably because the oxidation of the support material is also catalyzed by platinum. In addition, carbon promotes the undesirable formation of H₂O₂ in the electrolysis.

Silver likewise has a high catalytic activity for the reduction of oxygen.

Silver can be used in carbon-supported form or as finely divided metallic silver.

OCEs comprising carbon-supported silver usually have a silver loading of 20-50 g/m². Although the carbon-supported silver catalysts are more durable than the corresponding platinum catalyst, their long-term stability under the conditions of chloralkali electrolysis is limited.

Preference is given to using unsupported silver as catalyst. In the case of OCEs having catalysts composed of unsupported metallic silver, there are naturally no stability problems due to decomposition of the catalyst support.

In the production of OCEs having an unsupported silver catalyst, the silver is preferably introduced at least partly in the form of silver oxides which are then reduced to metallic silver. The reduction of the silver compounds also results in a change in the arrangement of the crystallites, in particular also to bridge formation between individual silver particles. This leads overall to strengthening of the structure.

In the manufacture of oxygen-consuming electrodes, a distinction can be made in principle between dry manufacturing processes and wet manufacturing processes.

In dry production processes, a mixture of catalyst and polymeric component (usually PTFE) is milled to give fine particles which are subsequently distributed on an electrically conductive support element and pressed at room temperature. Such a process is, for example, described in EP 1728896 A2.

In the case of wet manufacturing processes, either a paste or a suspension consisting of catalyst and polymeric component in water or another liquid is used. In the production of the suspension, it is possible to add surface-active substances in order to increase the stability of the suspension. A paste is subsequently applied by screen printing or calendering to the support, while the less viscose suspension is usually sprayed on. The support together with the applied paste or suspension is dried and sintered. Sintering is carried out at a temperature in the region of the melting point of the polymer. Furthermore, densification of the OCE can also be effected at a temperature higher than room temperature (up to the melting point, softening point or decomposition point of the polymer) after sintering.

The silver oxide-based electrodes produced by these known processes are installed without further treatment in the electrolyser. The reduction of the silver oxide to metallic silver is effected, after filling of the electrolyser with the electrolyte then present therein, during the first start-up, i.e. after switching-on of the electrolysis current.

It has now been found that silver oxide-based electrodes have a series of disadvantages during handling. Thus, the catalyst layer is not very mechanically stable, as a result of which damage such as flaking-off of parts of the unreduced catalyst layer can easily occur. Especially when the silver-oxide-based electrodes are installed in the electrolyser, the silver oxide-based electrode has to be bent sharply. The resulting damage leads to leaks during operation.

Electrodes for industrial plants are frequently produced in central manufacturing locations and transported from there to the individual use sites. This places particular demands on the transport capability and storage capability. The OCEs have to be insensitive to mechanical and thermal stresses during transport and during installation on site.

There can likewise be a long period of time between manufacture of the silver oxide-based electrode and its installation in the electrolyser and also between installation of the silver oxide-based electrode in the electrolyser and start-up of the electrolyser.

When the silver oxide-based sheet-like structure has been installed in the electrolyser and is left for a relatively long period of time without the electrolyser being started up, a deterioration in performance can occur. In the electrolyser, there is the ion-exchange membrane which has to be kept moist. The installed silver oxide-based electrode is therefore always exposed to a high ambient moisture level which has a negative influence on the noble metal oxides. Incipient hydrolysis processes presumably change the particle surface of the electrocatalyst and thus the electrochemically active surface area present after the reduction. This change has, for example, an adverse effect on the electrolysis voltage during operation.

The activity of the OCE formed is influenced, inter alia, by the conditions under which the silver oxide is reduced to metallic silver. In an industrial plant for the preparation of chlorine and sodium hydroxide, it cannot be ensured that the optimum conditions for reduction are maintained during start-up of a silver oxide-based electrode.

Methods of reducing silver oxides in electrodes are described, for example, in DE 3710168 A1. Mention is made of cathodic reduction in potassium hydroxide solution and chemical reduction using zinc. It is likewise stated that the silver oxide-based sheet-like structure can be installed in an electrolyser and reduction of the silver oxide is carried out at the commencement of electrolysis.

In practice, reduction using zinc or other metals involves considerable problems. Particular problems which may be mentioned are contamination of the electrode with the respective metal or metal oxide and the risk of blocking of the pores.

When the reduction of the silver oxide-based sheet-like structure is carried out during start-up of the chloralkali electrolysis, it has been found in our unpublished experiments that the chloride content of the alkali metal hydroxide solution increases greatly during start-up. This occurred particularly when electrolytes were heated in the industrial electrolysers. In industrial electrolysers, the heat-up phase up to the temperature at which the rectifier can be switched on typically takes up to 4 hours. During this time, the electrolytes are pumped through the electrolyser and the heat exchanger which is located in every electrolyte circuit. In the electrolyser, chloride ions obviously migrate through the ion-exchange membrane into the alkali metal hydroxide solution and continuously increase the content of chloride ions. When the electrolysis current is finally switched on, reduction of the silver oxide-based sheet-like structure takes place in the presence of a highly chloride-containing electrolyte, as a result of which the performance of the resulting OCE is greatly impaired, as observed.

In DE 3710168, it is stated that the reduced OCE is irrigated and subsequently dried. The disadvantage of irrigation is that prolonged contact of the OCE with water and residues of electrolytes which have penetrated into the OCE or of electrolytes adhering to the OCE occurs, which can cause damage to the OCE.

Reduction of the silver oxide of the silver oxide-based electrode under the conditions of chloralkali electrolysis, i.e., for example, in about 30% strength by weight sodium hydroxide solution, leaves, as has likewise been observed, a large amount of highly concentrated alkali metal hydroxide solution in the pore system of the OCE, and this is difficult to remove. During storage of such an electrode, the alkali metal hydroxide solution can be concentrated by evaporation of water. The alkali metal hydroxide can crystallize out and thereby block the pores of the electrode or irreversibly destroy the pores as a result of the crystals being formed. To avoid the problems mentioned, the alkali metal hydroxide solution would have to be removed completely from the electrode after the reduction. This can be carried out only with difficulty in the case of a finely porous electrode. Since a silver oxide-based electrode which has been reduced in concentrated alkali metal hydroxide solution also always contains traces of the highly concentrated alkali metal hydroxide solution, installation of the electrode in the electrolyser is made difficult by increased safety measures (avoidance of burns by highly concentrated alkali metal hydroxide solution).

The temperature change stresses, in particular, occurring during storage can lead to evaporation and condensation of water, as a result of which changes in the structure occur due to crystallization and dissolution processes of the alkali metal hydroxides, and these can in turn lead to destruction of the pore system of the electrode.

The methods mentioned are not very suitable for producing silver oxide-based oxygen-consuming electrodes which make good performance, i.e. a very low cell voltage, satisfactory mechanical stability and high storage stability possible.

It is an object of the present invention to provide a ready-to-function oxygen-consuming electrode, in particular for use in chloralkali electrolysis, which has good performance and is transport-stable and storage-stable.

The specific object of the present invention is to discover a process by means of which silver oxide-containing intermediates can be converted into an oxygen-consuming electrode (hereinafter also referred to as OCE for short) which has, firstly, a high-performance silver catalyst layer which is stable in the long term. Secondly, the oxygen-consuming electrode formed should be insensitive to damage during transport and storage and also to moisture and be sufficiently mechanically stable for installation in the electrolyser.

The invention provides a process for producing a transport-stable, storage-stable and mechanically stable sheet-like oxygen-consuming electrode comprising at least a support which is, in particular, electrically conductive, and further comprising a gas diffusion layer and a layer containing a silver-based catalyst, characterized in that the support is coated with a silver oxide-containing mixture of electrocatalyst and a hydrophobic material to form a silver oxide-containing sheet-like structure as intermediate and the silver oxide-containing sheet-like structure is electrochemically reduced in an aqueous electrolyte at a pH of at least 10, in particular in the presence of alkali metal hydroxide, particularly preferably sodium hydroxide, and the resulting electrode is subsequently freed very completely of the aqueous electrolyte. Freed of the electrolyte in this case means that essentially the water is removed from the electrodes.

The temperature of the electrolyte is preferably from 10 to 90° C., particularly preferably from 20 to 80° C., very particularly preferably from 30 to 60° C. The current density in the reduction is preferably at least 0.01 kA/m², particularly preferably from 0.01 to 6 kA/m², during the reduction.

In a preferred embodiment, the electrolyte consists of an aqueous alkali metal hydroxide solution in which the concentration of alkali metal hydroxide is at least 0.001 mol/l, preferably from 0.001 to 3.2 mol/l. In addition, one or more salts of an element from the alkali metal or alkaline earth metal group, preferably alkali metal sulphates or alkali metal nitrates, particularly preferably alkali metal nitrates, are preferably added to the electrolyte in order to increase its electrical conductivity.

As addition to the electrolyte, it is also possible to use, in particular, complex silver cyanides such as sodium cyanoargentate or potassium cyanoargentate or silver molybdate. Combinations of a plurality of salts can also be used as electrolyte. Thus, for example, a mixture of sodium nitrate and sodium sulphate can preferably be used as addition.

In a preferred embodiment, it is possible to add further additives as are, for example, known in principle from electrochemical technology, in particular surface-active substances, to the electrolyte. The silver oxide-containing sheet-like structure as intermediate for the electrode comprises, in particular, at least silver oxide powder pressed together with a finely divided, in particular hydrophobic material, preferably PTFE powder, optionally additionally silver powder and further fillers, e.g. zirconium dioxide.

The reduction of the silver oxide-based sheet-like structure can be carried out in a cell consisting of an anode, an electrolyte and a device for accommodating and supplying charge to the silver oxide-based sheet-like structure to be connected cathodically. Here, it is possible to use techniques known from electrochemical technology.

Anode and the silver oxide-based sheet-like structure can dip into a chamber without separation. However, since hydrogen can be evolved at the OCE being formed during the course of the electrochemical reduction and this hydrogen would form an explosive mixture with the oxygen formed at the anode, it is advantageous and preferred to separate anode and cathode physically. This can, for example, occur by means of a diaphragm or a membrane. The gases arising in the respective gas space can then be discharged separately. The hazard posed by hydrogen can, however, also be avoided by other methods known to those skilled in the art, for example by flushing the gas space above the electrode with an inert gas.

The anode is configured in a manner known to a person skilled in the field of electrolysis. Shape and arrangement are preferably selected in such a way that the current density is uniformly distributed over the cathode. The anode is preferably made of titanium or nickel, in particular in the form of titanium expanded metal or coated nickel, in particular a platinum-plated nickel sheet. The anode can be coated on the surface with further materials, e.g. iridium oxide, which reduce the overvoltage of oxygen evolution. Furthermore, it is possible to use two anodes with the intermediate located between them, so that electrochemical reduction of the silver oxide-based sheet-like structure can occur from two sides. This accelerates the process for producing the electrode.

The concentration of the alkali metal hydroxide in the electrolyte is preferably selected in a wide range, in particular at least 0.001 mol/l, particularly preferably from 0.001 mol/l to 3.2 mol/l, with the concentration also being able to be determined by the solubility in the electrolyte. Preference is given to selecting a concentration of the electrolyte which makes a small voltage drop over the electrolyte possible and thus allows the electrolysis voltage to remain as low as possible.

The pH of the electrolyte is greater than or equal to pH 10 and is, for practical reasons, preferably less than or equal to pH 14.5. To regulate the pH, buffer substances such as sodium phosphates can preferably also be added to the electrolyte.

It has been found, in particular, that a greater concentration of chloride ions in the electrolyte has an adverse effect on the performance of the OCE produced. There is a risk that silver chloride, which is considerably more difficult to reduce than silver oxide, can be formed in the electrode. In a preferred embodiment of the novel process, it should therefore be ensured that few or no chloride ions are present in the electrolyte. The chloride content of the electrolyte should therefore be not more than 1000 mg/l, particularly preferably not more than 700 mg/l, very particularly preferably not more than 500 mg/l, of chloride in a preferred embodiment of the novel process.

When anode space and cathode space are separated by a membrane, it is possible to use different electrolytes on the anode side and the cathode side. On the cathode side, the requirements which the electrolyte has to meet remain the same as when the cell is operated without separation of anode space and cathode space. However, on the anode side, it is possible to use electrolytes which are independent of the requirements which the electrolyte has to meet on the cathode side. Thus, it is possible to use an alkali metal hydroxide solution having a very high alkali metal hydroxide content as electrolyte on the anode side; the increase in the hydroxide ion concentration results in a reduction in the voltage drop over the electrolyte on the anode side.

The electrolyte can be conditioned using the techniques known in electrochemical technology, for example circulation by pumping, cooling, filtration.

The silver oxide-containing sheet-like structure to be reduced is, in a preferred process, introduced into the apparatus for electrochemical reduction in such a way that the current flux is uniform over the entire electrode surface and uniform reduction can take place over the entire surface. Such techniques are known in principle to those skilled in the art. When different coatings are present on the front and rear sides of the electrically conductive support element, the arrangement is, for example, preferably with the side of the sheet-like structure having the higher content of silver oxide facing the anode.

In a preferred embodiment of the novel process, the silver oxide-based sheet-like structure is conditioned by placing in water or preferably in the electrolyte to be used later during the reduction before it is introduced into the reduction apparatus. Conditioning can take place over a plurality of hours, preferably from at least 0.01 to 8 hours, and has the objective of filling the hydrophilic pores as completely as possible with liquid or electrolyte.

There are various possible ways of supplying current to the silver oxide-based sheet-like structure. Thus, the current can be supplied via the support in the case of an electrically conductive support, for example by the support not being coated in its peripheral region and the current being supplied via a clip or other connection through the electrically conductive support.

However, the supply of current can also be effected via an electrically conductive component, for example expanded metal or a woven metal mesh or knitted mesh, placed over the area of the silver oxide-based sheet-like structure. In such an arrangement, the transmission of current occurs via many contact points between coating and electrically conductive component.

In a preferred embodiment of the process, the reduction advantageously takes place at a current density of at least 0.01 kA/m². A current density below 0.01 kA/m² is likewise possible, but unnecessarily increases the time required to produce the electrode. However, reduction is preferably carried out at a considerably higher current density. Thus, a current density of at least 0.5 kA/m² is preferably used. Since the outlay in terms of apparatus increases with increasing current density, the practicable upper limit would at present be 6 kA/m², with reduction also being able to be carried out in principle, as long as the technical prerequisites are satisfied, at a higher current density up to 10 kA/m² and above. A particularly preferred process is therefore characterized in that the reduction is carried out at a current density of from 0.01 to 6 kA/m².

The current density can be kept constant from the beginning to the end of the reduction. However, it is also possible and particularly preferred to start the reduction at a relatively low current density and then to increase the current density gradually or in steps. This results in more uniform silver formation and avoids local silver nests which form more hydrogen.

The duration of the reduction depends on the desired degree of reduction, the current density, the loading of the electrode with silver oxide and the losses due to secondary reactions.

In general, it is sufficient, in a preferred embodiment of the process, for about 50% of the silver oxide in the sheet-like intermediate to be reduced to metallic silver in order to obtain, in particular in the case of rapid further processing of the electrodes in electrolysers, an OCE which is sufficiently strong for transport. However, in order to rule out problems, for example as a result of changes in the remaining silver oxide caused by moisture, particular preference is given to a reduction of more than 90%, very particularly preferably complete reduction (100%). The degree of reduction is recognized from the extent of hydrogen evolution and the resulting increase in the electrolysis voltage.

It is known that an amount of charge of 1000 coulomb (corresponding to 1000 ampere×second) is required for the reduction of 1.118 g of monovalent silver ions; in the case of divalent silver, twice the amount of charge is required. At a loading of 4600 g of silver(I) oxide per m², 1064 Ah are theoretically required for complete reduction. Owing to secondary reactions, the amount of charge actually required will be higher.

The duration of the reduction can be controlled via the electrolysis current selected.

During the reduction, the electrolyte heats up. The heat involved can be removed by appropriate cooling. Here, the electrolyte can be circulated by pumping in the electrolyser, if a heat exchanger is installed in the electrolyser itself. As an alternative, the heat exchanger can also be installed outside the cell, in which case an external electrolyte circuit is necessary. However, the reduction can also be carried out adiabatically with increasing electrolyser temperatures.

In a preferred embodiment of the novel process, the gas diffusion layer and the catalyst-containing layer are formed by a single layer. This is, for example, achieved by the gas diffusion layer and the catalyst-containing single layer being formed on the support by use of a single mixture of silver oxide-containing powder and hydrophobic powder, in particular PTFE powder, and then being reduced by means of the novel process.

In a preferred variant of the novel process, the gas diffusion layer and the catalyst-containing layer are formed by at least two different layers. This is achieved, for example, by the gas diffusion layer and the layers containing the catalyst being formed in two or more layers on the support by use of at least two different mixtures of silver oxide-containing powder and hydrophobic powder, in particular PTFE powder, having different contents of silver oxide and then being reduced by the novel process.

The manufacture of an OCE by the process of the invention will be described in detail below, without the validity of the invention being restricted to the specific embodiments presented below.

The silver oxide-containing intermediate is produced, for example, in a manner analogous to the techniques known per se for producing OCEs by wet or dry production processes.

For example, an aqueous suspension or paste used is produced from silver oxide powder, a fluorine-containing polymer, for example polytetrafluoroethylene (PTFE), and optionally a thickener (for example methylcellulose) and an emulsifier in the wet production process by mixing the components using a high-speed mixer. For this purpose, a suspension in water and/or alcohol is firstly produced from silver oxide powder, the thickener (for example methylcellulose) and the emulsifier. This suspension is then mixed with a suspension of a fluorine-containing polymer as is, for example, commercially available under the name DYNEON™ TF5035R. The emulsion or paste obtained in this way is then applied by known methods to a support, dried and sintered, with this process being able to be repeated a number of times. In order to make supply of current by direct contact with the support element possible in the subsequent reduction, the periphery of the electrically conducting support element can be kept free of the coating.

As an alternative, in the particularly preferred dry production process, a powder mixture is produced by mixing a mixture of PTFE or another fluorine-containing polymer, silver oxide and optionally additionally silver particles in a mixer having fast-rotating mixing tools. In the mixing process, it in each case needs to be ensured that, in particular, the temperature of the mixture is kept in a range from 35 to 90° C., particularly preferably from 40 to 80° C.

The powder mixture is then applied in a manner known per se to a support and densified. To allow current to be supplied via direct contact with the support element during the subsequent reduction, the periphery of the support element can, in the case of an electrically conductive support, be kept free of the coating here, too.

The silver oxide-containing sheet-like structure produced by the wet or dry process can, according to the above-described process, be conditioned in a bath containing water or an electrolyte for up to a number of hours. The temperature can be from 10 to 90° C.

The optionally conditioned electrode is then transferred into an apparatus for electrochemical reduction.

An oxygen-evolving electrode is preferably selected as anode in the reduction. This can, for example, be a platinum-coated nickel sheet or a titanium sheet coated with iridium oxide. However, it is also possible to use other anode forms such as meshes or expanded metals.

The area of the anode should preferably be at least as large as the area of the silver oxide-containing sheet-like structure to be reduced.

A current density of from 0.01 to 6 kA/m² is preferably selected for the reduction. The electrolysis voltage is determined by the arrangement of the electrodes/diaphragms or ion exchangers in the electrolysis cell and the type of electrolyte.

The electrode spacing is preferably from 0.5 to 4 cm and is preferably minimized.

The storage-stable finished OCE is subsequently taken from the electrolysis cell. Adhering electrolyte is allowed to run off, which can be assisted by further techniques known per se to those skilled in the art, for example blowing with air. The OCE can then be rinsed with deionized water, for example by spraying or dipping into a bath containing deionized water. To remove electrolyte from the pore system, the OCE can be stored for a prolonged period, for example for 30 minutes, in a water bath at 20° C. or a higher temperature.

The OCE is subsequently dried. Drying can be effected by storage in air at ambient temperature, at temperatures of from 0 to 30° C. or in dryers at elevated temperatures and/or under reduced pressure. The temperature during drying is selected so that a drying time of more than 0.05 hour is obtained.

The structure of the OCE produced in this way has been significantly strengthened. The OCE is insensitive to mechanical damage and can be transported and, for example, installed in a chloralkali electrolysis cell without problems. The OCE retains its activity even after prolonged storage in a humid atmosphere, as occurs, for example, within electrolysers. In the case of operation in industrial chloralkali electrolysers, attention advantageously no longer has to be paid to the chloride concentration in the alkali metal hydroxide solution when starting up an OCE obtainable from the novel process.

The invention therefore also provides an oxygen-consuming electrode obtained from the novel process.

The oxygen-consuming electrode produced by the process of the invention is preferably connected as cathode, in particular in an electrolysis cell for the electrolysis of alkali metal chlorides, preferably of sodium chloride or potassium chloride, particularly preferably of sodium chloride.

The oxygen-consuming electrode produced by the process of the invention can likewise preferably be connected as cathode in a fuel cell. Preferred examples of such fuel cells are alkaline fuel cells. A further possible use is a metal-air battery.

The invention therefore further provides for the use of the oxygen-consuming electrode produced by the process of the invention for the reduction of oxygen in an alkaline medium, in particular as oxygen-consuming cathode in electrolysis, preferably in chloralkali electrolysis, or as electrode in a fuel cell or as electrode in a metal/air battery.

The invention is illustrated by the examples, which, however, do not constitute a restriction of the invention.

### EXAMPLES

### Example 1

### According to the Invention

3.5 kg of a powder mixture consisting of 7% by weight of PTFE powder, DYNEON™ (fluorine-containing polymer), type 2053, 88% by weight of silver(I) oxide and 5% by weight of silver powder of the type 331 from Ferro were mixed in an Eirich mixer, type R02, equipped with a star swirler as mixing element at a rotation speed of 5000 rpm in such a way that the temperature of the powder mixture did not exceed 55° C. This was achieved by the mixing process being interrupted at a temperature close to 55° C. and the mixture being cooled. Overall, mixing was carried out three times. After mixing, the powder mixture was sieved using a sieve having a mesh opening of 1.0 mm.

The sieved powder mixture was subsequently applied to a mesh (support) made of nickel and having a wire thickness of 0.14 mm and a mesh opening of 0.5 mm. Application was carried out with the aid of a 2 mm thick template, with the powder being applied by means of a sieve having a mesh opening of 1 mm. Excess powder which projected beyond the thickness of the template was removed by means of scrapers. After removal of the template, the support together with the applied powder mixture was pressed by means of a roller press at a pressing force of 0.5 kN/cm. The silver oxide-based sheet-like structure (OCE intermediate) was taken from the roller press.

The OCE intermediate was subsequently introduced into an electrolyser which contained an alkali metal hydroxide solution having a pH of 13.5 as electrolyte. Electrical contacting of the OCE intermediate was effected via the nickel mesh onto which the powder mixture had been applied. The counterelectrode was titanium expanded metal coated with iridium oxide. The anode and the OCE intermediate had a spacing of 4 cm. The silver oxide-based side of the OCE intermediate was positioned in opposition to the anode.

The OCE intermediate was conditioned for 2 hours at room temperature in the electrolyte before the electrolysis current was switched on.

The OCE intermediate was galvanostatically reduced at a current density of 1 kA/m² until the electrolysis voltage rose.

The finished OCE was subsequently taken from the electrolyser. After adhering electrolyte had run off, the electrode was rinsed with deionized water in an electrolyser and then stored in air for 24 hours. The average temperature here was 21° C.

The finished OCE was used in the electrolysis of a sodium chloride solution in an electrolysis cell having a DuPONT N982WX ion-exchange membrane and a sodium hydroxide gap between OCE and membrane of 3 mm. The electrolysis voltage was 2.02 V at a current density of 4 kA/m², an electrolyte temperature of 90° C. and a sodium hydroxide concentration of 32% by weight. A commercial titanium electrode having a noble metal oxide-based coating from DENORA was used as anode for production of chlorine at an NaCl concentration of 210 g/l.

The potential of the finished OCE was measured in the electrolysis cell relative to the reverse hydrogen electrode by means of electrochemical impedance spectroscopy (EIS) and was 801 mV. The potential was corrected by the ohmic contributions. The correction factor for the electrolyte resistance was determined from the EIS measurement and was used to correct the potential of the OCE measured relative to the reverse hydrogen electrode under these conditions.

### Example 2

### According to the Invention

The production of the silver oxide-based sheet-like structure was carried out as described in Use Example 1.

For the reduction, the OCE intermediate having an effective area of 10×10 cm was installed in an electrolysis cell having an electrolyte volume of 3.2 1. A sodium hydroxide solution having a concentration of 0.01 mol/l was used as electrolyte. To cool the electrolyte to the intended temperature of 20° C., the electrolyte was pumped 12 times per hour through a heat exchanger connected to a cryostat. A platinum-coated titanium expanded metal electrode was used as anode, and the electrode spacing was 4 cm. The electrolysis cell was operated galvanostatically using a rectifier (Statron GmbH 36 V/40 A).

The OCE intermediate was installed dry in the electrolysis cell in such a way that the silver oxide-containing side of the OCE intermediate was opposite the anode. 10 minutes after installation of the electrodes and introduction of the electrolyte, the current was switched on. Owing to the poor electrical conductivity of the electrolyte, only a current density of 0.2 kA/m² could be employed. After 117 minutes, there was a significant increase in the cell voltage. The electrolysis was stopped after the cell voltage remained approximately constant after the measured increase. After the electrolysis, the OCE which had been reduced under these conditions was taken from the cell and rinsed with deionized water.

Immediately after the rinsing process, the electrochemical behaviour of the reduced OCE was characterized by means of electrochemical impedance spectroscopy (EIS). The measurements were carried out in a half cell from Gaskatel in which the cathode process of chloralkali electrolysis can be modelled. For the studies, a specimen having dimensions of 7×3 cm was taken from the reduced OCE and clamped into the cell as cathode in such a way that it separated the electrolyte space and the gas space. The effective area of the cathode was 3.14 cm². A platinum foil served as anode and a reverse hydrogen electrode served as reference electrode. The electrolyte was 32% strength sodium hydroxide solution. A current density of 4 kA/m² was applied to the OCE and the electrolyte was at the same time heated to 80° C. Oxygen (99.5%) was introduced into the gas space. When the electrolyte temperature was reached, the EIS measurement was carried out in the frequency range from 100 mHz to 20 kHz. The correction factor for the electrolyte resistance at the current density of 4 kA/m² was determined from the EIS measurement and was used to correct the potential of the OCE measured relative to the reverse hydrogen electrode under these conditions. The corrected potential of the oxygen-consuming electrode which had been reduced under these conditions was 785 mV relative to the standard hydrogen electrode.

### Example 3

### According to the Invention

The production of the OCE intermediate was carried out as described in Use Example 1.

For the prereduction, the OCE intermediate having an effective area of 22×18 cm was installed in an electrolysis cell having an electrolyte volume of 20.5 1. A sodium hydroxide solution having a concentration of 0.5 mol/l was used as electrolyte. To maintain the temperature of the electrolyte at the intended temperature of 40° C., the electrolyte was pumped 2.3 times per hour through a low-temperature cooler connected to a cryostat. The electrolyte was introduced on both sides of the OCE via frits so as to avoid direct flow onto the OCE. An iridium oxide-coated titanium expanded metal anode was used as counterelectrode, and the electrode spacing was 4 cm.

The silver oxide-based sheet-like structure was installed dry in the electrolysis cell in such a way that the silver oxide-containing side was opposite the anode. 30 minutes after installation of the electrode and introduction of the electrolyte, the current was switched on. The cathodic current density was 1 kA/m². After 25 minutes, there was an increase in the cell voltage to about 1 V. After a total of 30 minutes, the reduction process was stopped. The OCE which had been reduced in this way was taken from the cell and both sides of the electrode were briefly rinsed with deionized water. The electrode was dried at room temperature in air and stored for 7 days under these conditions before electrochemical characterization.

The electrochemical characterization was carried out by means of electrochemical impedance spectroscopy as described in Use Example 2. At a current density of 4 kA/m², the corrected potential of the OCE which had been reduced under these conditions was 803 mV relative to the reverse hydrogen electrode.

### Example 4

### According to the Invention

The production of the OCE intermediate was carried out as described in Use Example 1.

For the prereduction, the OCE intermediate having an effective area of 10×10 cm was installed dry in an electrolysis cell having an electrolyte volume of 3.2 1. A sodium hydroxide solution having a concentration of 0.5 mol/l was used as electrolyte. To maintain the temperature of the electrolyte at the intended temperature of 40° C., the electrolyte was pumped about 12 times per hour through a heat exchanger connected to a cryostat. As a difference from the previous use examples, the electrolysis cell contained two anodes which consisted of iridium oxide-coated titanium expanded metal. The silver oxide-based sheet-like structure was hung as cathode centrally between the two anodes; the spacing from the anodes was in each case 4 cm.

30 minutes after introduction of the electrolyte, the current was switched on. An experiment using a current density of 0.5 kA/m² in which the reduction was stopped after 26 minutes was firstly carried out. After reduction, the OCE was taken from the cell and rinsed with deionized water. Without changing the electrolyte, a new silver oxide-based sheet-like structure was installed as cathode in the cell and this time reduced at a current density of 1 kA/m². The reduction time was in this case 13 minutes. After reduction, the OCE was taken from the cell and rinsed with deionized water.

Immediately after the rinsing process, the electrochemical behaviour of the two reduced OCEs was characterized by means of electrochemical impedance spectroscopy as in Use Example 2. At a current density of 4 kA/m², the corrected potential of the reduced OCE was 796 mV relative to the reverse hydrogen electrode.

### Example 5

### Comparative Example

The production of the OCE intermediate was carried out as described in Use Example 1.

For the prereduction, the OCE intermediate having an effective area of 10×10 cm was installed dry in an electrolysis cell having an electrolyte volume of 3.2 1. As a difference from the previous use examples, a potassium sulphate solution having a concentration of 50 g/l and to which H₂SO₄ had been added so that the pH of the electrolyte used was 4.6 was used as electrolyte. To maintain the temperature of the electrolyte at the intended temperature of 20° C., the electrolyte was pumped about 12 times per hour through a heat exchanger connected to a cryostat. The electrolysis cell contained one anode which consisted of platinum-coated titanium expanded metal. The spacing between the silver oxide-based sheet-like structure functioning as cathode and the anode was 6.5 cm.

30 minutes after introduction of the electrolyte, the current was switched on. Reduction took place at a current density of 1.5 kA/m² and was stopped after 35 minutes. After the reduction, the OCE was taken from the cell and rinsed with deionized water.

Immediately after the flushing process, the electrochemical behaviour of the reduced OCE was characterized by means of electrochemical impedance spectroscopy as described in Use Example 2. At a current density of 4 kA/m², the corrected potential of the reduced OCE was 697 mV relative to the reverse hydrogen electrode. Owing to the about 100 mV lower corrected potential of the reduced OCE described in this example compared to the inventive production process described in Use Examples 1-4, an at least 100 mV higher electrolysis voltage of the chloralkali electrolysis described in Use Example 1 is to be expected.

### Example 6

### Comparative Example

The production of the OCE intermediate was carried out as described in Use Example 1.

For the prereduction, the OCE intermediate having an effective area of 10×10 cm was installed dry in an electrolysis cell having an electrolyte volume of 3.2 1. As a difference from the previous use examples, a sodium sulphate solution having a concentration of 50 g/l was used as electrolyte. The pH of the electrolyte used was 6.1. To maintain the temperature of the electrolyte at the intended temperature of 20° C., the electrolyte was pumped about 12 times per hour through a heat exchanger connected to a cryostat. The electrolysis cell contained one anode which consisted of platinum-coated titanium expanded metal. The spacing between the silver oxide-based sheet-like structure functioning as cathode and the anode was 6.5 cm.

30 minutes after introduction of the electrolyte, the current was switched on. Reduction took place at a current density of 0.3 kA/m² and was stopped after 95 minutes. After the reduction, the OCE was taken from the cell and rinsed with deionized water.

Immediately after the flushing process, the electrochemical behaviour of the reduced OCE was characterized by means of electrochemical impedance spectroscopy as described in Use Example 2. At a current density of 4 kA/m², the corrected potential of the reduced OCE was 641 mV relative to the reverse hydrogen electrode. Owing to the about 150 mV lower corrected potential of the reduced OCE described in this example compared to the inventive production process described in Use Examples 1-4, an at least 150 mV higher electrolysis voltage of the chloralkali electrolysis described in Use Example 1 is to be expected.

What is claimed is:

1. A process for producing a sheet-like oxygen-consuming electrode comprising at least a support, a gas diffusion layer and a layer containing a silver-based catalyst, said process comprising (a) coating the support with a silver oxide-containing mixture of electrocatalyst and a hydrophobic material to form a silver oxide-containing sheet-like structure as an intermediate, (b) electrochemically reducing the silver oxide-containing sheet-like structure in an aqueous electrolyte at a pH of at least 10 to yield said electrode, and (c) freeing the electrode of the aqueous electrolyte.

2. Process according to claim 1, wherein the support is electrically conductive.

3. Process according to claim 1, wherein the electrolyte additionally comprises at least one of salts of an element of the alkali metal or alkaline earth metal group.

4. Process according to claim 3, wherein the electrolyte additionally comprises at least one of alkali metal sulphates, alkali metal nitrates, or mixtures of alkali metal sulphates and alkali metal nitrates.

5. Process according to claim 1, which further comprises carrying out the electrochemically reducing at a current density of at least 0.01 kA/m².

6. Process according to claim 1, wherein the electrolyte comprises not more than 1000 mg/l of chloride.

7. Process according to claim 1, which further comprises carrying out the electrochemically reducing at a temperature in the range from 10 to 90° C.

8. Process according to claim 1, which further comprises reducing the silver oxide in the silver oxide-containing sheet-like structure to an extent of more than 50%.

9. Process according to claim 1, wherein the silver oxide-containing sheet-like structure as intermediate for the electrode comprises at least silver oxide powder pressed together with polytetrafluoroethylene (PTFE) powder.

10. Process according to claim 1, which further comprises arranging the silver oxide-containing sheet-like structure as intermediate for the electrode between two anodes during the electrochemically reducing.

11. Process according to claim 1, which further comprises pretreating the silver oxide-based sheet-like structure by placing the silver oxide-based sheet-like structure in water or in the electrolyte used later during the electrochemically reducing, before introducing into an apparatus for carrying out the electrochemically reducing.

12. Process according to claim 5, which further comprises carrying out the electrochemically reducing at a current density of 0.01 to 6 kA/m².

13. Process according to claim 1, which further comprises freeing the electrode of the electrolyte after the electrochemically reducing by rinsing and treating with deionized water and subsequently drying.

14. Process according to claim 1, wherein the gas diffusion layer and the layer containing electrocatalyst are formed by a single layer.

15. Process according to claim 1, wherein the gas diffusion layer and the layer containing electrocatalyst are formed by at least two different layers.

16. Oxygen-consuming electrode obtained by a process according to claim 1.

17. A fuel cell or a metal-air battery comprising an oxygen-consuming electrode according to claim 16.

18. A process comprising conducting an electrolysis process in the presence of an oxygen-consuming electrode according to claim 16.

19. Process according to claim 18, which is a chloralkali electrolysis.
